(19) United States
(12) Patent Application Publication
(10) Pub. No.: US 2013/0064498 A1
(43) Pub. Date: Mar. 14, 2013

(54) OPTICAL SUB-ASSEMBLY MODULE AND INTERMEDIATE OPTICAL MECHANISM

(71) Applicant: Hui-Tsuo Chou, Zhubei City (TW)

(72) Inventor: Hui-Tsuo Chou, Zhubei City (TW)

(73) Assignee: OptoMedia Technilogy Inc.

(21) Appl. No.: 13/610,558

(22) Filed: Sep. 11, 2012

Related U.S. Application Data
(60) Provisional application No. 61/534,856, filed on Sep. 14, 2011.

(51) Int. Cl. G02B 6/12

(52) U.S. Cl. 385/14

(57) ABSTRACT

An optical sub-assembly module comprises a fiber for delivering optical signals; a transmitter; a receiver; and an intermediate optical mechanism optically coupled to the fiber, the transmitter and the receiver. The intermediate optical mechanism includes a fiber-end interface for receiving the optical signals from the fiber or outputting the optical signals generated by the transmitter to the fiber; a transmission-end interface for receiving the optical signals from the transmitter; a reception-end interface or outputting the optical signals from the fiber to the receiver; and a filtering interface in the inside of the intermediate optical mechanism for realizing the optical signal delivery from the transmitter to the fiber and from the fiber to the receiver. The fiber-end interface, the transmission-end interface and the reception-end interface are parts of an integral whole while the filtering interface is a part of the same integral whole or an independent filter.

### CROSS-REFERENCE TO RELATED APPLICATIONS

This application claims the benefit of the filing date priority of a co-pending U.S. Provisional Application No. 61/534,856 filed on Sep. 14, 2011, the disclosure of which is incorporated herein by reference in its entirety.

### BACKGROUND OF THE INVENTION

1. Field of the Invention

The present invention relates to optical devices, especially to an optical sub-assembly module and an intermediate optical mechanism.

2. Description of Related Art

As the demand of data communication throughput keeps rising, optical communication no doubt has played the role of the backbone for realizing a communication network. Originally, optical communication is applied to distant transmission for delivering a huge amount of data between cities, or even between countries. In recent times, optical communication technique gradually gets into office or family use. More and more consumer products employ optical communication technique for transmitting a large number of data, e.g. video data, in a relatively short distance, which ensures a higher transmission rate, better signal quality, and strong tolerance to electromagnetic interference. However, the price of optical communication products remains high because a plurality of lenses is required to couple light into a fiber or a receiver, and accurate and precise alignment is a must to make sure of optical signals transmitted in the right path. More specifically, once more lenses and other components such as filters (aka. beam splitters) are used in an optical communication device, not only the cost of materials gets higher, but also the alignment becomes difficult due to the chain effect of adjustment. Therefore, a cost effective and simple design for an optical communication device is strongly felt by the practitioners in this filed.

### SUMMARY OF THE INVENTION

In order to solve the problems mentioned above, the present invention provides an optical sub-assembly module and an intermediate optical mechanism which are relatively cost effective and simple.

The present invention discloses an optical sub-assembly module for realizing the transmission of optical signals. The sub-assembly module comprises: a fiber for delivering optical signals; a transmitter for generating optical signals; a receiver for receiving and processing optical signals; and an intermediate optical mechanism optically coupled to the aforementioned fiber, transmitter and receiver. The intermediate optical mechanism includes: a fiber-end interface which is a first part of the exterior of the intermediate optical mechanism, for receiving the optical signals from the fiber or outputting the optical signals from the transmitter to the fiber; a transmission-end interface which is a second part of the exterior of the intermediate optical mechanism, for receiving the optical signals from the transmitter; a reception-end interface which is a third part of the exterior of the intermediate optical mechanism, for outputting the optical signals from the fiber to the receiver; and a filtering interface in the inside of the intermediate optical mechanism, functioning as a filtering means for realizing the optical signal delivery from the transmitter to the fiber or from the fiber to the receiver. Furthermore, at least one of the aforementioned fiber-end interface, the transmission-end interface and the reception-end interface functions as a lens for refracting light; and the fiber-end interface, the transmission-end interface and the reception-end interface are parts of an integral whole while the filtering interface is a part of the integral whole or an independent filter.

In an embodiment of the present invention, the intermediate optical mechanism of the optical sub-assembly module includes a room in the inside thereof for carrying out the filtering interface. The room can be in a triangle shape or another shape that won't substantially degrade the filtering effect; and the filtering interface can be a wall of the room or the independent filter positioned in the room for passing or rerouting optical signals.

In another embodiment of the present invention, the filtering interface includes an inclined plane relative to a horizontal plane, or a curve for passing, refracting or reflecting optical signals.

In an embodiment of the present invention, the intermediate optical mechanism itself is the aforementioned integral whole made of glass or plastic material.

In an embodiment of the present invention, some or all of the surface of the intermediate optical mechanism is coated with a film for enhancing the effect of delivering optical signals. Similarly, a part or all of the filtering interface of the intermediate optical mechanism is coated with a film for enhancing optical transmission properties.

In an embodiment of the present invention, the optical sub-assembly module further comprises one or more additional receivers, one or more additional transmitters and one or more additional filtering interfaces for carrying out more delivery of optical signals.

The present invention also discloses an intermediate optical mechanism optically coupled to a fiber, a transmitter and a receiver. The intermediate optical mechanism comprises: a fiber-end interface which is a first part of the exterior of the intermediate optical mechanism, for receiving the optical signals from the fiber or outputting the optical signals from the transmitter to the fiber; a transmission-end interface which is a second part of the exterior of the intermediate optical mechanism, for receiving the optical signals from the transmitter; a reception-end interface which is a third part of the exterior of the intermediate optical mechanism, for outputting the optical signals from the fiber to the receiver; and a filtering interface in the inside of the intermediate optical mechanism, functioning as a filtering means for realizing the optical signal delivery from the transmitter to the fiber or from the fiber to the receiver, wherein at least one of the fiber-end interface, the transmission-end interface and the reception-end interface functions as a lens, and the fiber-end interface, the transmission-end interface and the reception-end interface are parts of an integral whole while the filtering interface is a part of the integral whole or an independent filter.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 is an active circuit device of the present invention.

FIG. 2 is an optical coupling system of the present invention.

FIG. 3 is another optical coupling system of the present invention.

FIG. 4 is yet another optical coupling system of the present invention.

FIG. 5 is a bidirectional optical system of the present invention.

FIG. 6 is another bidirectional optical system of the present invention.

FIG. 7 is an optical tri-plexer system of the present invention.

FIG. 8a is an optical sub-assembly module of the present invention.

FIG. 8b is the exploded view of FIG. 8a.

FIG. 9a is a tri-plexer optical sub-assembly module of the present invention.

FIG. 9b is the exploded view of FIG. 9a.

FIG. 10 shows the transmission and receiving optical mechanical parts of FIGS. 2-7.

FIG. 11 shows a fiber fixed on a plastic substrate.

FIG. 12 shows the integration of a plastic substrate and an optical mechanism.

FIG. 13 shows the assembly of optical components.

FIG. 14 is a fiber communication module of the present invention.

### DETAILED DESCRIPTION OF THE PREFERRED EMBODIMENTS

In the following description, technical or descriptive terms mostly refer to the phrases commonly used in the related filed. The explanation or definition thereof shall be interpreted in accordance with this description first. Prepositions, under the requirement of enablement, are used in the following paragraphs to indicate the direct or indirect mutual relationship between two or more objects or events in a spatial or time domain. The shape, size and scale of the elements illustrated in the figures or description of this specification are exemplary, not restrictive, for understanding. Furthermore, on the basis of the description of the present invention, a person of ordinary skill in the art can choose or pool together some or all of the inventive features in one or several embodiments to carry out an equivalent of the present invention without making unreasonable effort, which makes the implementation of the present invention more flexible.

The present invention discloses a plurality of optical devices including an optical sub-assembly module and an intermediate optical mechanism which can be used in the optical sub-assembly module. Since some components of the plurality of optical devices and the operation thereof are well-known in this filed, detail explanation to these known components is thereby omitted while the disclosure and enablement requirements remain unaffected.

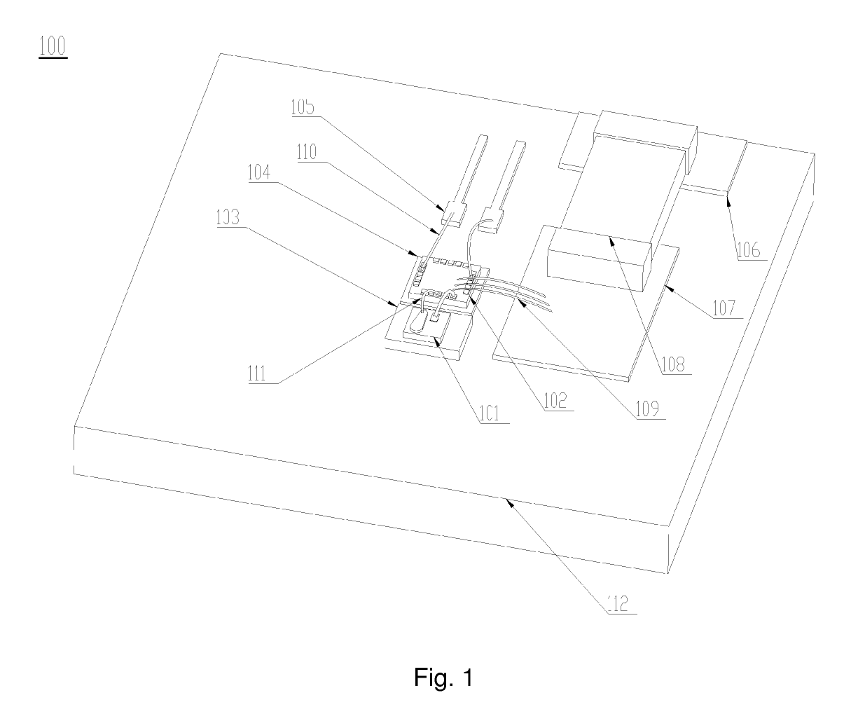

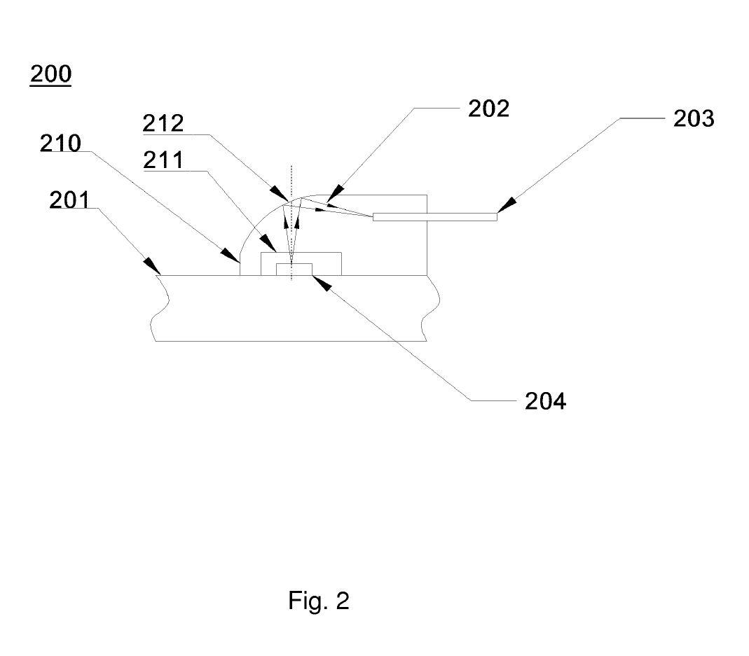

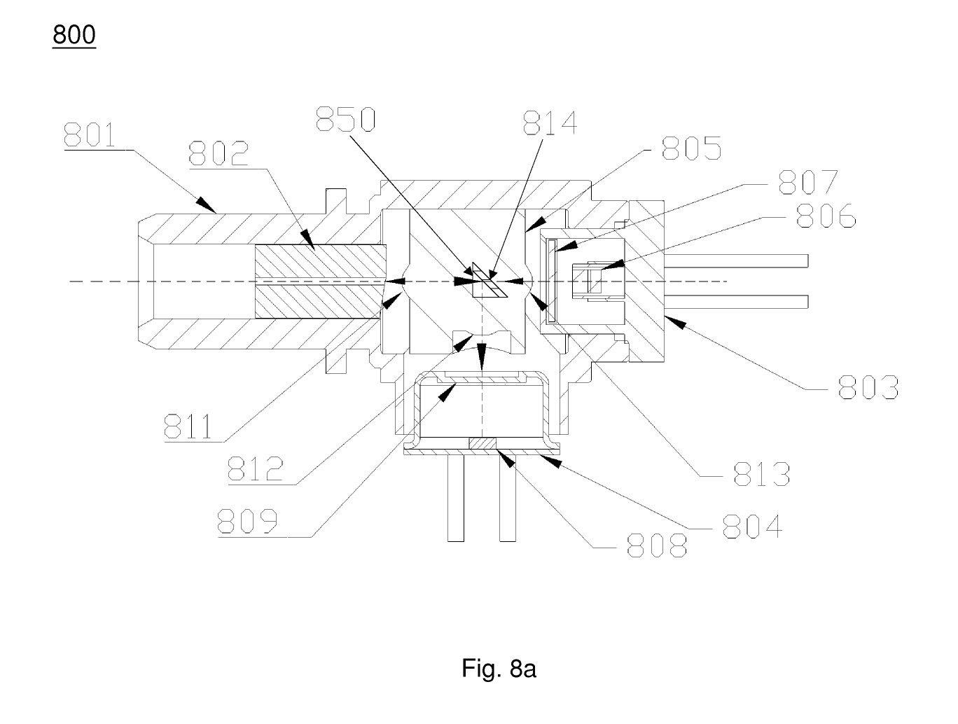

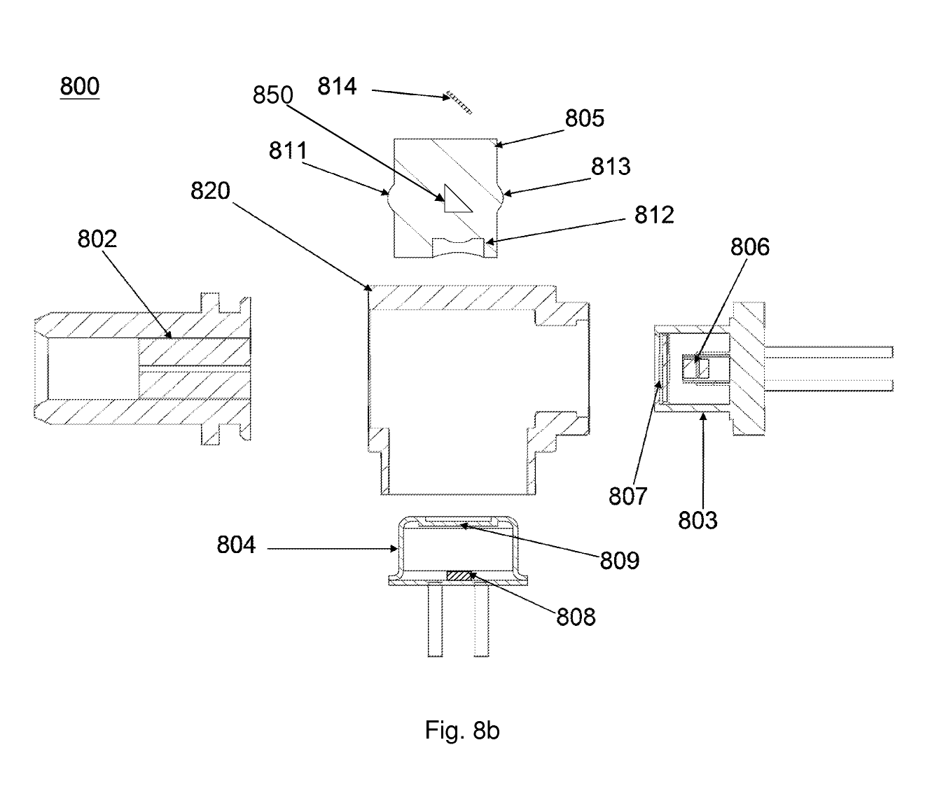

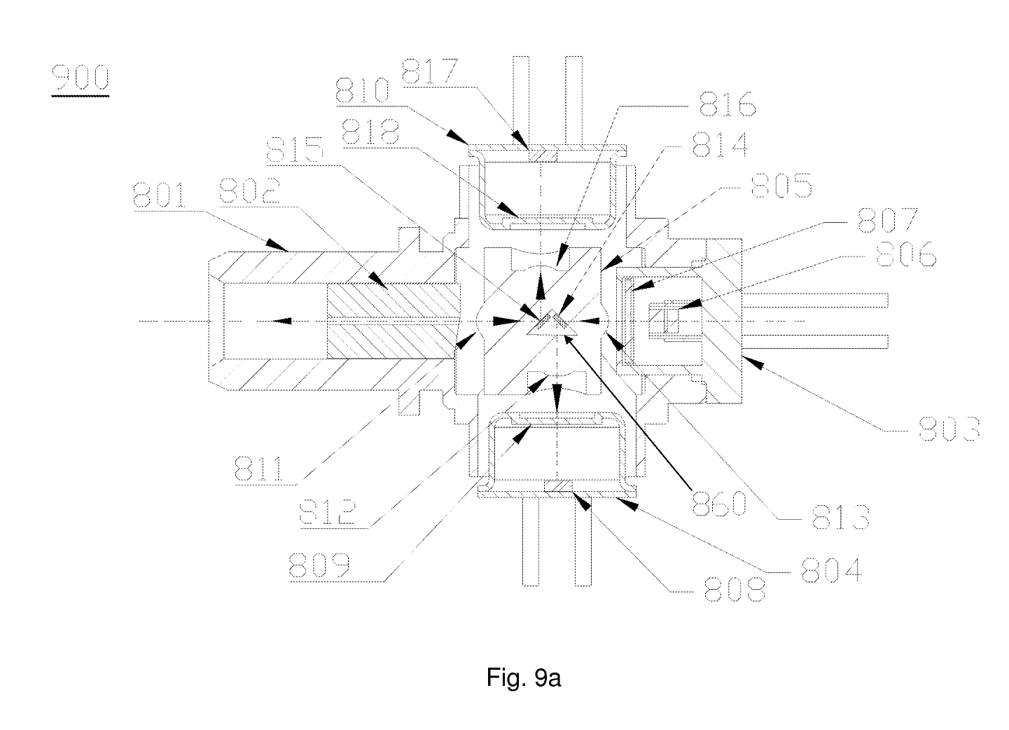

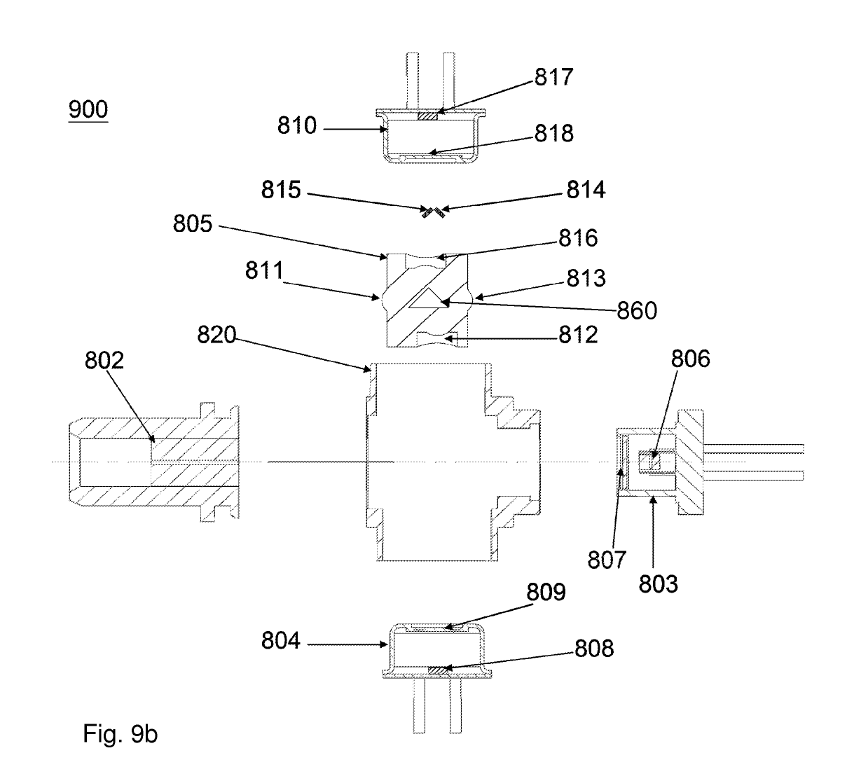

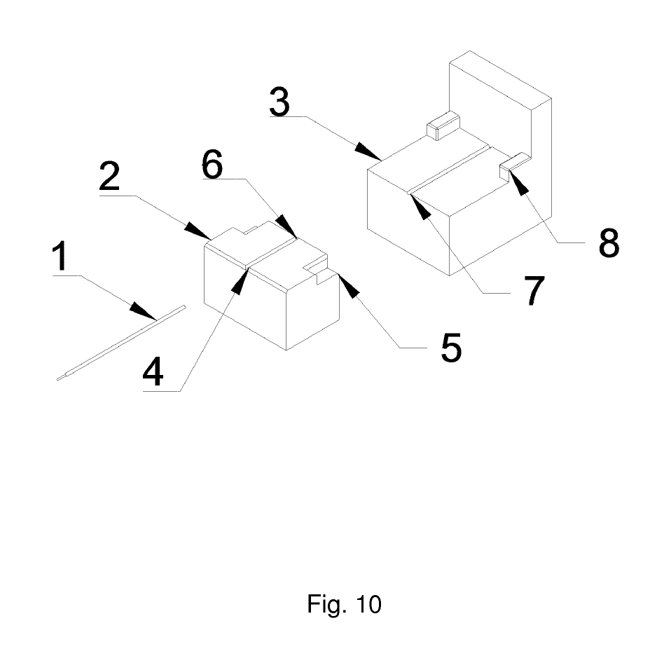

Generally, the optical fiber transmitting and receiving system includes an optical coupling mechanism and an active circuit. FIG. 1 shows an active circuit device 100. This active circuit device 100 could be a transmitter or a receiver. FIGS. 2˜7 respectively illustrate an optical fiber transceiver system integrating an optical coupling mechanism and the active circuit device 100. The design reduces optical subassembly complexity and increases coupling efficiency. The assembly processes of some of those disclosed optical mechanical parts are shown in FIGS. 10, 11, 12, and 13. The optical sub-assembly modules (OSA) in FIGS. 8a, 9a respectively use an intermediate optical mechanism with lens design.

The active circuit device 100 includes an optical device 101, an IC dice 102, copper pads and trace lines 103, 104, 105, 106, 107, a passive component 108, wires 109, 110, 111, and a substrate 112. The optical device 101 could be a laser diode or a photo-detector diode and bonded to the copper pad 103. The IC dice 102 can be a laser driver or an amplifier and bonded to the copper pad 104. The optical device 101 and IC dice 102 are connected by a wire which is bonded to a device pad 103 or a copper pad 104. The I/O of the IC dice 102 is connected to the copper pad 104 and trace 105.

FIGS. 2˜4 illustrate several optical coupling systems (which could be optical transmitters or receivers) 200, 300, 400. The transmitter or the receiver includes the active circuit device 100 and an optical mechanism. The three optical mechanisms 210, 310 and 410 are made of plastic material or glass material.

FIG. 2 shows the optical coupling system 200. The optical mechanism 210 includes a flat window 211 and a lens 212. The lens 212 is coated for total reflection on the surface or uses the refractive index difference to reflect the laser light. Regarding transmitter end application, the optical device 204 is an optical transmitter device with a laser diode, a driving IC and other devices. The optical mechanism 210 and the active device are mounted on the substrate 201. The laser diode emits the laser light 202 to transmit data, video or other signals. The laser light 202 emitted from the laser diode, passes through the flat window 211 and goes into the optical mechanism 210. The laser light 202 is reflected by the lens 212 and focused on the fiber 203. Regarding receiver end application, the optical device 204 is an optical receiver device with a photo-detector diode, an amplifier IC and other devices. The laser light 202 from the fiber 203 is injected into the optical mechanism 210 and reflected by the lens 212. The laser light 202 is focused on the photo-detector and then converted to electrical signals by the amplifier IC.

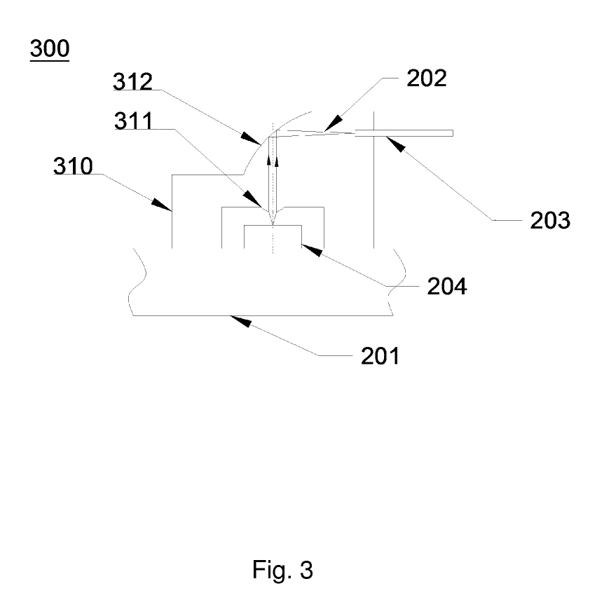

FIG. 3 shows the optical coupling system 300. The optical mechanism 310 includes a lens 311 and a lens 312. The lens 312 is coated for total reflection on the surface or uses the refractive index difference to reflect the laser light. Regarding transmitter end application, the optical device 204 is an optical transmitter device with a laser diode, a driving IC and other devices. The optical mechanism 310 and the active device are mounted on the substrate 201. The laser diode emits the laser light 202 to transmit data, video or other signals. The laser light 202 emitted from the laser diode, passes through the lens 311 and goes into the optical mechanism 310. The laser light 202 is reflected by the lens 312 and focused on the fiber 203 through the lenses 311, 312. Regarding receiver end application, the optical device 204 is an optical receiver device with a photo-detector diode, an amplifier IC and other devices. The laser light 202 from the fiber 203 is injected into the optical mechanism 310 and then reflected by the lens 312. The laser light is focused on the photo-detector through the lenses 311, 312 and converted to electrical signals by the amplifier IC.

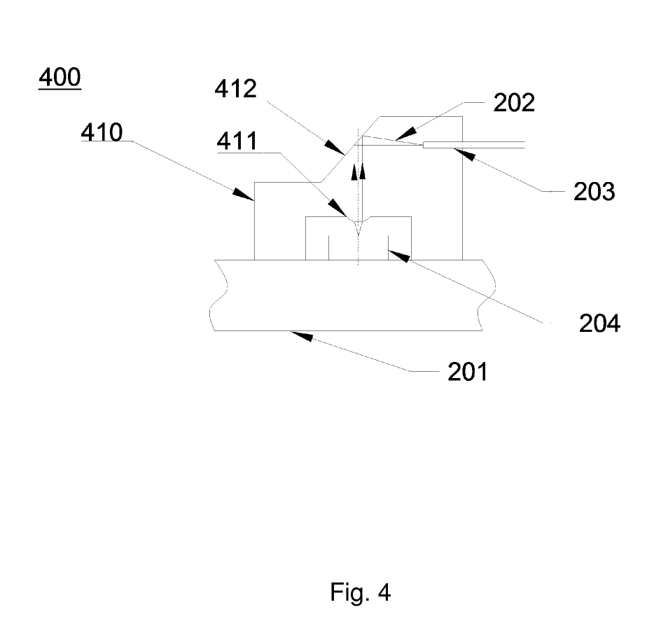

FIG. 4 shows the optical coupling system 400. The optical mechanism 410 includes a lens 411 and a flat mirror 412. The flat mirror 412 is coated for total reflection on the surface or uses the refractive index difference to reflect the laser light. In transmitter end application, the optical device 204 is an optical transceiver device with a laser diode, a driving IC and other devices. The optical mechanism 410 and the active device are mounted on the substrate 201. The laser diode emits the laser light 202 to transmit data, video or other signals. The laser light emitted from the laser diode passes through the lens 411. The laser light is reflected by the flat mirror 412 and focused on the fiber 203 through the lens 411 and the mirror 412. In receiver end application, the optical device 204 is an optical receiver device with a photo-detector diode, an amplifier IC and other devices. The laser light 202 from the fiber 203 is injected into the optical mechanism 410 and reflected by the flat mirror 412. The laser light 202 is focused on the photo-detector through the lens 411 and flat mirror 412 and then converted to electrical signals by the amplifier IC.

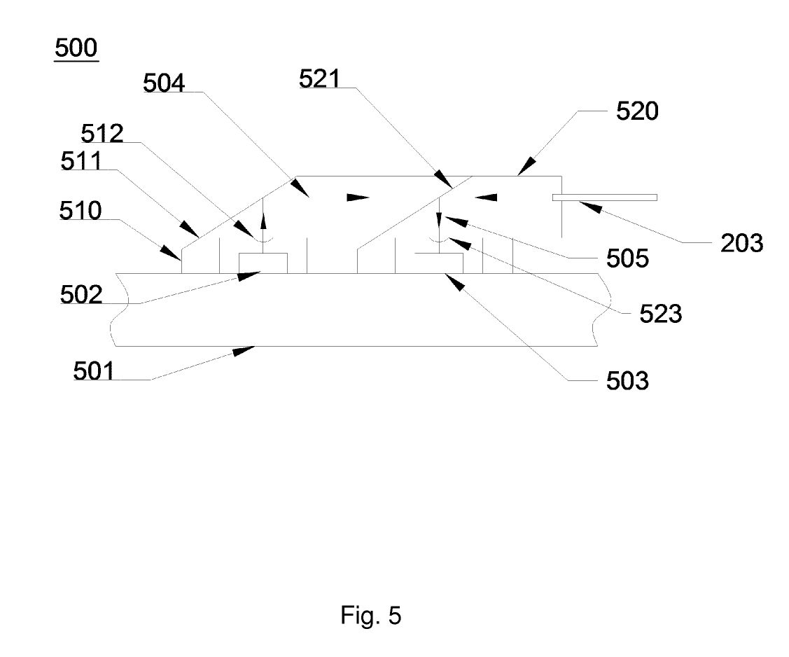

FIG. 5 is the bidirectional optical system 500 with a transmission device and a receiving device. The receiving device is close to the fiber 203 while the transmission device is far away from the fiber 203. The transmission device includes the optical transmission mechanism 510, while the optical active transmitter device 502 is mounted on the substrate 501. The optical active transmitter device 502 includes a laser diode and a laser driver circuit. The optical transmission mechanism 510 includes the flat mirror 511 which can reflect the laser light 504 of wavelength λ1, and a lens 512. The flat mirror 511 can be a reflective layer coating the surface of the optical transmission mechanism 510 or a reflective mirror attached to the optical transmission mechanism 510, which uses the refractive index difference to reflect the laser light 504. The receiving device includes an optical receiving mechanism 520 and an optical active receiving device 503. The optical active receiving device 503 includes a photo-detector and an amplifier circuit. The laser diode emits the laser light 504 of wavelength λ1. The photo-detector receives the laser light 505 of wavelength λ2 from the fiber 203. The wavelengths λ1 and λ2 are different. The optical receiving mechanism 520 includes a lens 523 and an optical filter 521. The laser light 505 of wavelength λ2 can be totally reflected while the laser light 504 of wavelength λ1 can pass through the optical filter 521. The laser light 504 of wavelength λ1 is focused by the lens 512 and the flat mirror 511, passes through the optical filter 521 and injects into the fiber 203. The laser light 505 of wavelength λ2 come from the fiber 203 is reflected by the filter 521, and received by a photo-detector and transformed into electrical signals.

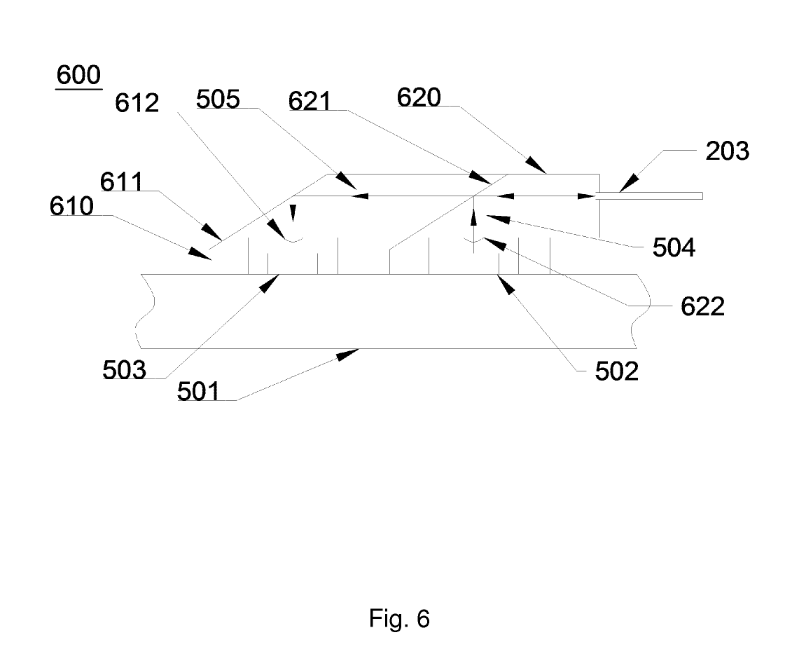

FIG. 6 is the bidirectional optical system 600 with a transmission device and a receiving device. The transmission device is close to the fiber 203 while the receiving device is far away from the fiber 203.

The transmission device includes the optical transmission mechanism 620 and the optical active transmitter device 502. The optical active transmitter device 502 includes a laser diode and a laser driver circuit. The optical transmission mechanism 620 includes an optical filter 621 and a lens 622. The optical filter 621 can allow the laser light 505 of wavelength λ2 to pass and reflect the laser light 504 of wavelength λ1. The laser diode emits the laser light 504 of wavelength λ1. The photo-detector receives the laser light 505 of wavelength λ2 from the fiber 203. The wavelengths λ1 and λ2 are different. The optical filter 621 can be a reflective layer coating the surface of the optical transmission mechanism 620, or a reflective mirror attached to the optical transmission mechanism 620.

The receiving device includes an optical receiving mechanism 610 and the optical active receiving device 503. The optical active receiving device 503 includes a photo-detector and an amplifier circuit. The optical receiving mechanism 610 includes a lens 612 and a flat mirror 611 which can reflect the laser light 505 of wavelength λ2. The flat mirror 611 can be a reflective layer coating the surface of the optical transmission mechanism 610 or a reflective mirror attached to the optical transmission mechanism 610. The laser light 505 come from the fiber 203, reflected by the flat mirror 611, focused by a lens 612, is received by a photo-detector and then transformed to electrical signals.

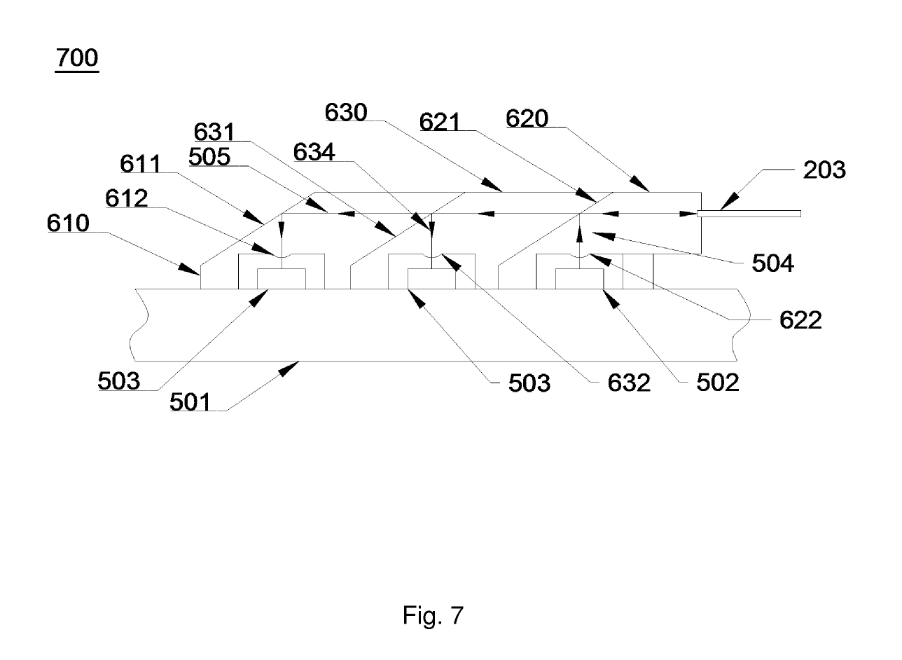

FIG. 7 is the optical tri-plexer system 700. The tri-plexer system 700 includes one transmission device and two receiving devices. This design is derived form the bidirectional optical systems 500, 600. One receiver device is added, including an optical receiving mechanism 630 and an optical active receiving device 503. This system can transmit and receive three different wavelengths λ1 504, λ2 505 and λ3 634. The optical receiving mechanism 630 includes a lens 632 and an optical filter 631 which can reflect the wavelength λ3 634 and pass the wavelength λ2 505; this optical filter could be a reflective layer on the surface of the optical transmission mechanism 630 or is a reflective mirror attached to the optical transmission mechanism 630. The reflected wavelength λ3 from the fiber 203 is focused on the optical receiving device 503 and transformed to electrical signals.

Please refer to FIGS. 8a and 8b. FIG. 8a is a bidirectional optical sub-assembly (OSA) module 800 of the present invention while FIG. 8b is the exploded view of FIG. 8a. As shown in the figures, the optical sub-assembly module 800 comprises a fiber 802 for delivering optical signals from a far end or a near end; a transmitter 803 for generating optical signals by a light source such as a laser diode 806; a receiver 804 for receiving optical signals by a photo detector such as a photo diode 808; and an intermediate optical mechanism 805 optically coupled to the fiber 802, the transmitter 803 and the receiver 804. The fiber 802 can deliver the optical signals of wavelength λ₁ from the far end to the receiver 804 through the intermediate optical mechanism 805, or deliver the optical signals of wavelength λ₂ from the near end, e.g. the transmitter 803, to the far end through the intermediate optical mechanism 805, in which the wavelengths λ₁ and λ₂ could be the same or different. The transmitter 803 could be packaged in the type of TO-CAN (Transistor-Outline Can) or another known packaging type, and include not only the laser diode 806, but also a window 807 pervious to light for letting out its generated optical signals. The receiver 804 could be also packaged in the type of TO-CAN or another known packaging type, include the photo diode 808 which can be integrated with an amplifier in an IC or operate with an independent amplifier, and further include a window 809 pervious to light for letting in the optical signals from the fiber 802. The intermediate optical mechanism 805 is designed to replace the function of one or more independent lenses and one or more filters to thereby make the optical sub-assembly module 800 more compact, save the cost of materials and the effort to perform alignment. Please note that the fiber 802, the transmitter 803 or the receiver 804 alone is well-known in this filed, which means that one of ordinary skill in the art can make appropriate changes to any of these components according to the current techniques while the detailed description thereof is thereby omitted here if such description is not related to the inventive features of the present invention.

Please continue to refer to FIGS. 8a and 8b. As shown in the figures, the intermediate optical mechanism 805 includes a fiber-end interface 811 which is a first part of the exterior of the intermediate optical mechanism 805, functioning as a fiber-end lens or a fiber-end window for receiving the optical signals from the fiber 802 or outputting the optical signals from the transmitter 803 to the fiber 802; a transmission-end interface 813 which is a second part of the exterior of the intermediate optical mechanism 805, functioning as a transmission-end lens or a transmission-end window for receiving the optical signals from the transmitter 803; a reception-end interface 812 which is a third part of the exterior of the intermediate optical mechanism 805, functioning as a reception-end lens or a reception-end window for outputting the optical signals from the fiber 802 to the receiver 804; and a filtering interface 814 in the inside of the intermediate optical mechanism 805, functioning as a filtering means for realizing the optical signal delivery from the transmitter 803 to the fiber 802 and from the fiber 802 to the receiver 804, wherein at least one of the fiber-end interface 811, the transmission-end interface 813 and the reception-end interface 812 functions as a lens for refracting light, and the fiber-end interface 811, the transmission-end interface 813 and the reception-end interface 812 are parts of an integral whole while the filtering interface 814 is a part of the same integral whole or an independent filter. In this embodiment, the fiber-end interface 811 and the transmission-end interface 813 include a convex surface respectively while the reception-end interface includes a concave surface. The convex or concave surface could be spherical or aspheric for concentrating optical signals or making the optical signals on the right path. However, in light of different design requirements or concepts, some of the fiber-end interface 811, the transmission-end interface 813 and the reception-end interface 812 can be designed to function as flat glass. To be more specific, as long as the accuracy for optical signal transmission and reception is acceptable, a person having ordinary skill in the art can make appropriate changes to some or all of the fiber-end interface 811, the transmission-end interface 813 and reception-end interface 812 to pass or reroute optical signals on the basis of the disclosure of the present invention.

In an embodiment of the present invention, the aforementioned integral whole, that is to say the unity including the fiber-end interface 811, the transmission-end interface 813 and the reception-end interface 812 with or without the filtering interface 814, is made of glass or a plastic material such as polycarbonate (PC) or polymethyl methacrylate (PMMA) through a molding process such as injection molding. However, other materials or compounds pervious to light and/or other processes can be used to fabricate the intermediate optical mechanism 805. Furthermore, the intermediate optical mechanism 805 includes a room 850 therein for realizing the filtering interface 814 which can be a wall of the room 850 or the aforementioned independent filter positioned in the room 850 (as illustrated in FIG. 8a). For instance, the room 850 can be in the shape of a triangle (as illustrated in FIGS. 8a, 8b) or a quadrant while the filtering interface 814 is an inclined plane, e.g. the hypotenuse wall of the triangular room 850, relative to a horizontal plane or the curve of the quadrant room; or the room 850 can be in the shape of a triangle, a square, a rectangle, a full or semi-sphere, a quadrant or a trapezoid while the filtering interface 814 is the independent filter disposed or formed inside the room 850. Please note that these examples are just for understanding, not limitations to the present invention. As long as the optical signals from the fiber 802 and the transmitter 803 can enter the room 850 and reach the filtering interface 814 along the right path, and then leave the room 850 along the predetermined path through the filtering interface 814, one having ordinary skill in the art, after reading the disclosure of the present invention, can follow other requirements to make the room 850 in any shape and use at least a wall of the room 850 or one or more independent filters inside the room 850 to accomplish the delivery of the optical signals.

In addition, if the filtering interface 814 is realized by using a wall of the room 850 instead of an independent filter, the intermediate optical mechanism 805 can be the aforementioned integral whole comprising the fiber-end interface 811, the transmission-end interface 813, the reception-end interface 812, and the filtering interface 814, which means that one intermediate optical mechanism 805 itself replaces a plurality of lenses and at least one filter, and consequently makes the optical sub-assembly module 800 compact, saves the cost of plural components and saves the effort to align these and other components. Even if the filtering interface 814 is realized by using an independent filter inside the room 850, the cost of lenses and the effort for alignment can also be saved. Besides, the aforementioned independent filter can be fixed and/or adjustable in the room 850; some or all of the surface of the intermediate optical mechanism 805 can be coated with a film (not shown) for enhancing the optical property thereof such as the refractive index difference between the intermediate optical mechanism 805 and the medium (e.g. air) outside it; similarly, some or all of the filtering interface 814 can also be coated with a film for enhancing the optical property thereof such as the refractive index difference between the filtering interface 814 and the medium (e.g. air in the room 850) around it.

In another embodiment, before fabricating the intermediate optical mechanism 805, at least a filter is positioned inside a mold in advance for forming the filtering interface 814 later. The intermediate optical mechanism 805 is then fabricated by a molding process with the mold and eventually left no room and no need for putting in another filter as the filtering interface 814 because there already exists one. In yet another embodiment, the intermediate optical mechanism 805 is made of at least two kinds of materials through a molding process to thereby form and use a junction of the two materials as the filtering interface 814. Both of the two embodiments provide the design without a room, and thereby demonstrate the flexibility of carrying out the present invention.

Please refer to FIGS. 9a and 9b, in which FIG. 9a is a tri-plexer optical sub-assembly module 900 of the present invention while FIG. 9b is the exploded view of FIG. 9a. Compared to the bidirectional optical sub-assembly module 800 as shown in FIGS. 8a and 8b, the tri-plexer optical sub-assembly module 900 comprises one additional receiver 810 while the intermediate optical mechanism 805 is modified accordingly. The additional receiver 810 can be packaged in the type of TO-CAN or another known packaging type, includes a photo detector 817 which could be integrated with an amplifier in an IC or operate with an independent amplifier, and further includes a window 818 pervious to light for letting in the optical signals from the fiber 802. The modified intermediate optical mechanism 805 includes the fiber-end interface 811, the transmission-end interface 813, the reception-end interface 812 and the filtering interface 814 as described in the previous paragraphs, and further includes: an additional reception-end interface 816 which is a fourth part of the exterior of the intermediate optical mechanism 805, functioning as an additional reception-end lens or an additional reception-end window for outputting the optical signals from the fiber 802 to the additional receiver 810; and an additional filtering interface 815 in the inside of the intermediate optical mechanism 805, functioning as an additional filtering means for realizing the optical signal delivery from the transmitter 803 to the fiber 802 and from the fiber 802 to the additional receiver 810.

In the present embodiment, the additional reception-end interface 816 is has a concave surface which could be spherical or aspheric for having optical signals on the right path. However, according to different design requirements or concepts, the additional reception-end lens could be just a window, e.g. flat glass, or have a convex surface provided that the accuracy for the optical signal reception is acceptable.

In the present embodiment, the intermediate optical mechanism 805 also includes a room 860 therein for realizing the aforementioned filtering interface 814 and the additional filtering interface 815 which can be another wall of the room 860 or an additional independent filter positioned in the room 860 (as illustrated in FIGS. 9a). The filtering interface 814 is in charge of passing the optical signals from the transmitter 803 to the fiber 802 and rerouting the optical signals from the fiber 802 to the receiver 804 through the filtering interface 815; meanwhile, the filtering interface 815 is in charge of passing the optical signals from the transmitter 803 to the fiber 802 through the and filtering interface 814 and rerouting the optical signals from the fiber 802 to the additional receiver 810. As what has been described above, on condition that the optical signals from the fiber 802 and the transmitter 803 can enter the room 860 and reach the filtering interfaces 814, 815 in the right path, and then leave the room 860 along the predetermined path through the filtering interfaces 814, 815, a person having ordinary skill in the art can follow other requirements to make the room 860 in any shape and use one or more walls of the room 860 or one or more independent filters inside the room 860 to accomplish the delivery of the optical signals.

Similarly, if the filtering interface 814 and the additional filtering interface 815 are realized by using one or more walls of the room 860 instead of independent filters, the intermediate optical mechanism 805 itself can be an integral whole comprising the fiber-end interface 811, the transmission-end interface 813, the reception-end interface 812, the additional reception interface 816 and the two filtering interfaces 814 and 815, which means that one intermediate optical mechanism 805 replaces a plurality of lenses and a plurality of filters and thereby achieves a compact and simple design, saves the cost of plural components and saves the effort to align these and other components. Even though any or both of the filtering interfaces 814, 815 are carried out by using independent filters disposed inside the room 860, the cost of lenses and the effort for alignment can also be saved. Other changes or modifications to the present embodiment could be derived from the previous paragraphs.

In another embodiment of the present invention, the optical sub-assembly module 800 or 900 can be modified to further comprise another or more additional receivers for receiving the optical signals from the fiber 802 through a well-modified intermediate optical mechanism 805 that has another or more additional reception-end interfaces and another or more additional filtering interfaces. In yet another embodiment of the present invention, the optical sub-assembly module 800 or 900 can be modified to further comprise one or more additional transmitters for outputting optical signals to the fiber 802 through another well-modified intermediate optical mechanism 805 having one or more additional transmission-end interfaces and one or more additional filtering interfaces. Of course the above-mentioned two embodiments can be merged to obtain an optical sub-assembly module with a plurality of receivers, a plurality of transmitters and an expanded intermediate optical mechanism; and since the related modification can be derived from the above disclosure of the present invention by a person of ordinary skill in this field, same or similar description is therefore omitted here to avoid redundancy.

Moreover, each of the optical sub-assembly modules 800 and 900 can comprise a housing 820 for accommodating the intermediate optical mechanism 805 and connecting with the fiber 802, the transmitter 803 and the receiver 804 or the receivers 804, 810. Additionally, the housing 820 can be designed to further encompass the partial or entire fiber 802, transmitter 803 and/or receiver 804 or receivers 804, 810; or the fiber 802, the transmitter 803 and the receiver 804 or receivers 804, 810 can have their own casings. Certainly, one of ordinary skill in the art can select a proper material for making the housing 820 and/or casings, and can appreciate that once the optical sub-assembly module 800 or 900 is modified, the housing 820 and/or casings should be altered correspondingly.

Please note that the intermediate optical mechanism 805 could be used in other optical devices or systems besides the optical sub-assembly modules 800 and 900. Using the intermediate optical mechanism 805 can save the assembly cost and effort, and improve the reliability due to the simplified structure.

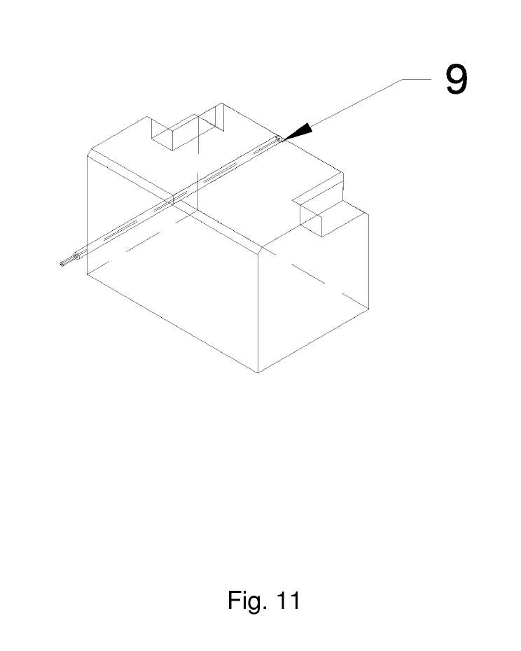

FIG. 10 shows the transmission and receiving optical mechanical parts of FIGS. 2, 3, 4, 5, 6, 7. It includes a fiber 1, a plastic substrate 2 and an optical mechanism with a lens 3. The end of the fiber 1 is cut to be a flat face. The plastic substrate 2 includes a v-grove 4, guide slots 5 and a positioning device 6. The v-grove 4 is for placing a fiber. The optical mechanism 3 includes a v-grove 7 and guide slots 8. The v-grove 7 is also for placing a fiber. The guide slots 5 and 8 are used for guidance when assembling the plastic substrate 2 and the optical mechanism 3. In the first step, the fiber is fixed on the plastic substrate 2 by using epoxy resin as shwon in FIG. 11 and the fiber-end should be in contact with the positioning device 6.

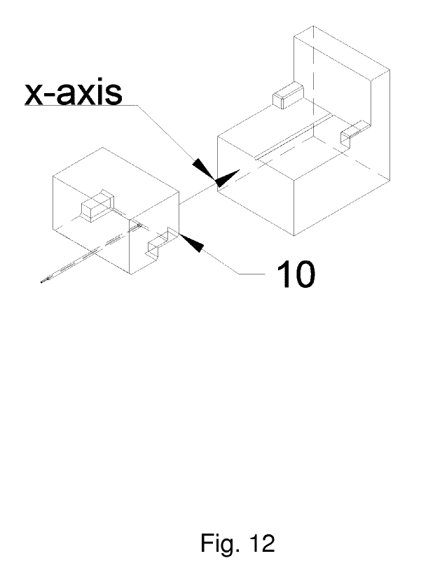

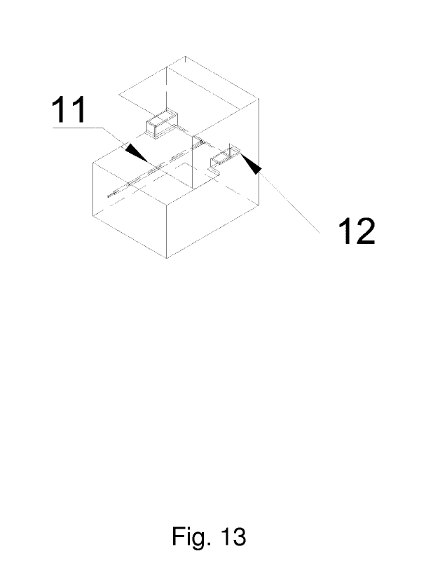

FIG. 12 shows the integration of the plastic substrate 2 and the optical mechanism 3. The plastic substrate 2 goes along the x-axis direction and thereby the best focus distance can be determined to cover all production tolerances. FIG. 13 is the final assembly installing all parts, and uses epoxy resin over the joint surface to fasten devices. The fixed points 11, 12 are exemplary, not limitations to this invention.

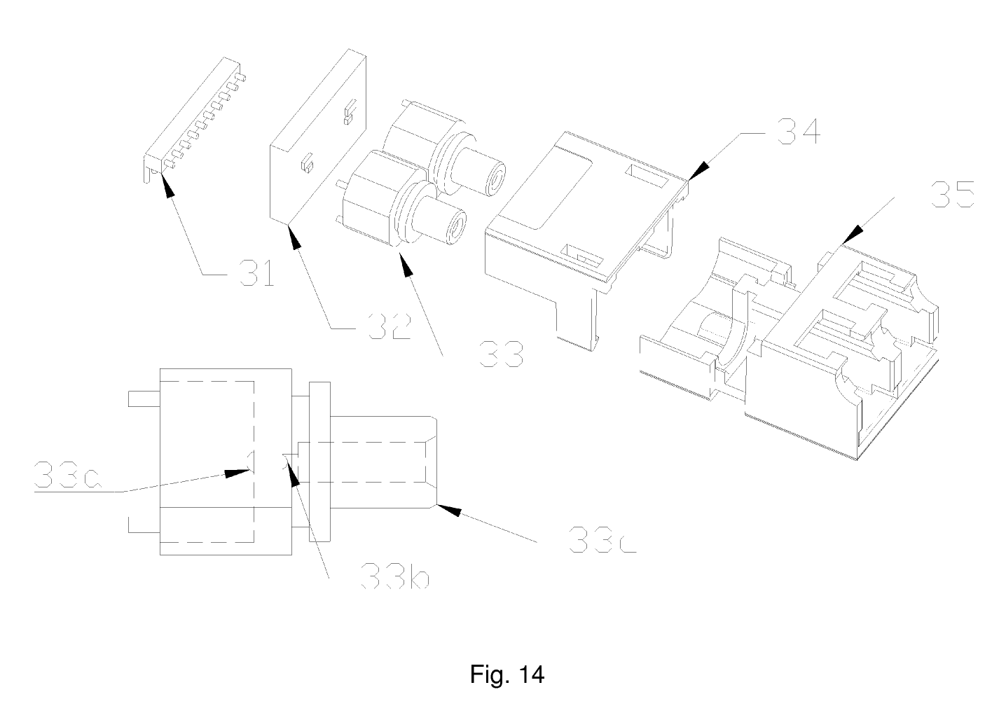

FIG. 14 is discloses a fiber communication module. The fiber communication module can reduce the size of that in the prior art. The fiber communication module includes an I/O pin 31, a substrate with the optical components and the active device 32, the optical mechanism 33, and the housings 34, 35. The optical mechanism 33 uses two lenses 33a, 33b (while in another embodiment only one lens 33b is used). These lenses are used to focus laser light on an optical device or a fiber. The receptacle 33c of the optical mechanism can be any optical connector type, e.g. LC, SC, FC, ST, and etc. The substrate and the optical mechanism 33 are assembled as shown in FIG. 14. In another embodiment, the design uses the optical mechanism as shown in FIG. 2, 3, 4, 5, 6, or 7 and the substrate is parallel to the direction of an input or output optical connector. The substrate can use a pin connector or an edge finger.

The aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

What is claimed is:

1. An optical sub-assembly module, comprising:
a fiber for delivering optical signals;
a transmitter for generating optical signals;
a receiver for receiving optical signals; and
an intermediate optical mechanism optically coupled to the fiber, the transmitter and the receiver, including:
a fiber-end interface which is a first part of the exterior of the intermediate optical mechanism, for receiving the optical signals from the fiber or outputting the optical signals from the transmitter to the fiber;
a transmission-end interface which is a second part of the exterior of the intermediate optical mechanism, for receiving the optical signals from the transmitter;
a reception-end interface which is a third part of the exterior of the intermediate optical mechanism, for outputting the optical signals from the fiber to the receiver; and
a filtering interface in the inside of the intermediate optical mechanism, functioning as a filtering means for realizing the optical signal delivery from the transmitter to the fiber and from the fiber to the receiver,
wherein at least one of the fiber-end interface, the transmission-end interface and the reception-end interface functions as a lens for refracting light, and the fiber-end interface, the transmission-end interface and the reception-end interface are parts of an integral whole while the filtering interface is a part of the integral whole or an independent filter.

2. The optical sub-assembly module of claim 1, wherein one of the fiber-end interface, the transmission-end interface and the reception-end interface functions as flat glass.

3. The optical sub-assembly module of claim 1, wherein one of the fiber-end interface, the transmission-end interface and the reception-end interface includes a convex surface which is spherical or aspheric while another one of the fiber-end interface, the transmission-end interface and the reception end interface includes a concave surface which is spherical or aspheric.

4. The optical sub-assembly module of claim 1, wherein the intermediate optical mechanism includes a room therein for realizing the filtering interface.

5. The optical sub-assembly module of claim 4, wherein the filtering interface includes a wall of the room.

6. The optical sub-assembly module of claim 4, wherein the filtering interface is the independent filter positioned in the room.

7. The optical sub-assembly module of claim 1, wherein the filtering interface includes an inclined plane relative to a horizontal plane for passing, refracting or reflecting optical signals.

8. The optical sub-assembly module of claim 1, wherein the filtering interface includes a curve for passing, refracting or reflecting optical signals.

9. The optical sub-assembly module of claim 1, wherein some or all of the surface of the intermediate optical mechanism is coated with a film for enhancing the optical property thereof.

10. The optical sub-assembly module of claim 1, wherein some or all the filtering interface of the intermediate optical mechanism is coated with a film for enhancing the optical property thereof.

11. The optical sub-assembly module of claim 1, wherein the integral whole is made of glass or plastic material.

12. The optical sub-assembly module of claim 1, further comprising one or more additional receivers for receiving the optical signals from the fiber through the intermediate optical mechanism.

13. The optical sub-assembly module of claim 12, wherein the intermediate optical mechanism further includes one or more additional filtering interfaces in the inside thereof for carrying out the optical signal delivery from the fiber to the one ore more additional receivers.

14. The optical sub-assembly module of claim 1, further comprising one or more additional transmitters for outputting optical signals to the fiber through the intermediate optical mechanism.

15. The optical sub-assembly module of claim 14, wherein the intermediate optical mechanism further includes one or more additional filtering interfaces in the inside thereof for carrying out the optical signal delivery from the one ore more additional transmitters to the fiber.

16. The optical sub-assembly module of claim 1, further comprising one or more additional receivers for receiving the optical signals from the fiber through the intermediate optical mechanism, one or more additional transmitters for outputting optical signals to the fiber through the intermediate optical mechanism and one or more additional filtering interfaces in the inside of the intermediate optical mechanism for carrying out the optical signal delivery from the fiber to the one ore more additional receivers and from the one ore more additional transmitters to the fiber.

17. The optical sub-assembly module of claim 1, further comprising a housing for accommodating the intermediate optical mechanism and connecting with the fiber, the transmitter and the receiver.

18. An intermediate optical mechanism optically coupled to a fiber, a transmitter and a receiver, comprising:
a fiber-end interface which is a first part of the exterior of the intermediate optical mechanism, for receiving the optical signals from the fiber and outputting the optical signals from the transmitter to the fiber;
a transmission-end interface which is a second part of the exterior of the intermediate optical mechanism, for receiving the optical signals from the transmitter;
a reception-end interface which is a third part of the exterior of the intermediate optical mechanism, for outputting the optical signals from the fiber to the receiver; and
a filtering interface in the inside of the intermediate optical mechanism, functioning as a filtering means for realizing the optical signal delivery from the transmitter to the fiber and from the fiber to the receiver,
wherein at least one of the fiber-end interface, the transmission-end interface and the reception-end interface functions as a lens, and the fiber-end interface, the transmission-end interface and the reception-end interface are parts of an integral whole while the filtering interface is a part of the integral whole or an independent filter.

19. The intermediate optical mechanism of claim 18, wherein one of the fiber-end interface, the transmission-end interface and the reception-end interface functions as flat glass.

20. The intermediate optical mechanism of claim 18, wherein one of the fiber-end interface, the transmission-end interface and the reception-end interface includes a convex surface while another one of the fiber-end interface, the transmission-end interface and the reception end interface includes a concave surface.
